(19) United States
(12) Patent Application Publication
(10) Pub. No.: US 2007/0158467 A1
(43) Pub. Date: Jul. 12, 2007

(54) Foam generator

(75) Inventors: Robin H. Knowles, Ruskin, FL (US); Lajos Pecsenka, Hudson, FL (US); Douglas G. Brown, Fort Myers, FL (US)

Correspondence Address: DAVID W. PETTIS, JR., PA, 1210 MILLENIUM PARKWAY, SUITE 2010, BRANDON, FL, 33511-0833, US

(73) Assignee: KENNCO MANUFACTURING, INC.

(21) Appl. No.: 11/330,295

(22) Filed: Jan. 11, 2006

(51) Int. Cl. A01G 25/09; B05B 7/30; B05B 7/04; B05B 9/03

(52) U.S. Cl. 239/398; 239/146; 239/344

(57) ABSTRACT

A foam generator employing a foam generator nozzle that injects compressed air and ambient air into the nozzle body where the air impinges upon a spray of foam liquid within the nozzle body is disclosed. The foam generator nozzle further includes spaced apart first and second fluid dispersion media downstream from the air-liquid mixture to generate a substantially dry foam suitable for application to agricultural crops for frost protection. The method for generating the substantially dry foam is also disclosed.

### BACKGROUND OF THE INVENTION

1. Field of the Invention

The present invention relates to a unique foam generator for producing and dispensing a substantially dry foam on an agricultural crop for frost protection. The foam generator utilizes a unique foam generator nozzle that injects compressed air and ambient air through a venturi nozzle body where the air impinges upon a spray of foam liquid within the nozzle body to create a first foam. The first foam passes, by excess air pressure, through a first fluid dispersion medium that is downstream from the venturi nozzle and the liquid nozzle to create a second foam. The second foam then passes through a second fluid dispersion medium downstream from the first fluid dispersion medium to generate the substantially dry foam suitable for application to agricultural crops. Operational parameters for generating the substantially dry foam are also disclosed and claimed.

2. Description of the Prior Art

Numerous devices, methods, and compositions useful for generating foams are certainly well known in the prior art. Such devices include aerosol dispensers for shaving cream, fire fighting equipment, and even the generation and application of foams on crops for frost protection. However, the foam generated by current, state of the art devices is substantially wet, and this is certainly the case with regard to virtually all fire fighting foams.

Even foams used in agricultural settings for frost protection are substantially wet, resulting in a foam that is dense as a result of a relatively high ratio of liquid to air. In fact, these prior art devices typically inject foaming liquid through a venturi, so that ambient air is drawn into the liquid stream for the purpose of generating the foam. In order to “lighten” the foam density in a number of prior art generator devices, the initial foam is then passed through one or more screens for the purpose of mechanically dividing the foam bubbles, but the resulting foam product is still unnecessarily wet and dense, which can render the foam unsuitable for agricultural use.

Wet foams not only have reduced insulating properties, but also actually may damage agricultural crops due to the weight of the applied foam. It is also desirable that foams applied to agricultural crops for frost protection should dissipate, leaving substantially no residue, within about 24-36 hours, and current, state of the art wet foams may actually leave harmful residues on the plants because of the relatively high liquid content of the foam composition. Finally, because current, state of the art wet foams include a relatively high concentration of the liquid component, the per-unit cost of such foams is necessarily greater than the cost of a dryer foam would be.

It is therefore clear that, notwithstanding the availability of current foam generators, there remains a need for a foam generator capable of producing and delivering a substantially dry foam that is suitable for application to agricultural crops for frost protection wherein the volume/volume ratio of foam liquid to foam output is greater than 1/100.

### SUMMARY OF THE INVENTION

The present invention relates to a foam generator for producing and dispensing a substantially dry foam on an agricultural crop for frost protection. The substantially dry foam is produced by a unique foam generator nozzle wherein compressed air is injected into a venturi nozzle designed and constructed to admit ambient air into the air stream as the compressed air passes through the venturi throat to the interior of the nozzle body. Downstream from the flow of compressed and ambient air, a liquid nozzle is positioned within the nozzle body to dispense droplets of foam liquid into the air stream. This results in the production of a first foam which is passed through a first fluid dispersion medium that is disposed within the nozzle body downstream from the liquid nozzle in transverse relation to the flow of the first foam. A second foam is generated by passage through the first fluid dispersion medium and next impinges upon and passes through a second fluid dispersion medium, further reducing the volume/volume ratio of liquid to air resulting in generation of the substantially dry foam which exits the nozzle body for application to the agricultural crop.

According to a preferred embodiment more fully described below, the foam generator of this invention is a tractor-drawn device designed and constructed to move over one or more rows of an agricultural crop without damaging the crop. It is intended that one nozzle will cover at least each row of living plants, and in cases where plants are in closely aligned parallel rows, a single foam generator nozzle will be sufficient for two rows of plants. It is of course to be understood that the foam generator of this invention may be constructed to include one or more foam generator nozzles.

Standard control valves are used for the purpose of precisely monitoring the pressure and flow rate of both the compressed air into the venturi nozzle and the foam liquid into the liquid nozzle. As set forth in greater detail below, the compressed air is injected at a pressure of about 2 psi to about 20 psi at a flow rate of about 14 cubic feet per minute (cfm) to about 221 cfm. The foam liquid is delivered to the liquid nozzle at a pressure of from about 100 psi to about 300 psi, and at a flow rate of about 0.22 gallons per minute (gpm) to about 1.02 gpm.

While a variety of foam liquids are available for use, of particular utility with the foam generator of this invention is the agricultural foam product disclosed in pending U.S. patent Ser. No. 11/054,759, filed Feb. 10, 2005.

The invention accordingly comprises the features of construction, combination of elements, and arrangement of parts which will be exemplified in the construction hereinafter set forth and the operating parameters defining the method for producing and dispensing a substantially dry foam.

### BRIEF DESCRIPTION OF THE DRAWINGS

For a fuller understanding of the nature and objects of the invention, reference should be had to the following detailed description taken in connection with the accompanying drawings, in which:

FIG. 1 is a side elevation of a preferred embodiment of the foam generator of this invention being tractor drawn over a crop row.

FIG. 2 is a side elevation of the foam generator illustrated in FIG. 1.

FIG. 3 is a side elevation of a preferred embodiment of the foam generator nozzle of the present invention.

FIG. 4 is a sectional view of the foam generator nozzle shown in FIG. 3, also showing the foam liquid conduit.

FIG. 5 is a sectional view of the venturi nozzle taken along line 5-5 of FIG. 4.

FIG. 6 is a sectional view of the interior of the nozzle body showing the first fluid dispersion medium and the liquid nozzle taken along line 6-6 of FIG. 4.

FIG. 7 is a sectional view of the interior of the nozzle body showing the second fluid dispersion medium and the liquid nozzle taken along line 7-7 of FIG. 4.

Similar reference characters refer to similar parts throughout the several views of the drawings.

### DETAILED DESCRIPTION

Referring to the view of FIG. 1, the foam generator of this invention is generally indicated as 10. In this preferred embodiment, foam generator 10 is mounted on trailer 12 and towed by tractor 14 over a row of agricultural crop, generally indicated as 16. A substantially dry foam 18 is shown as being dispensed from the foam generator nozzle, generally indicated as 20.

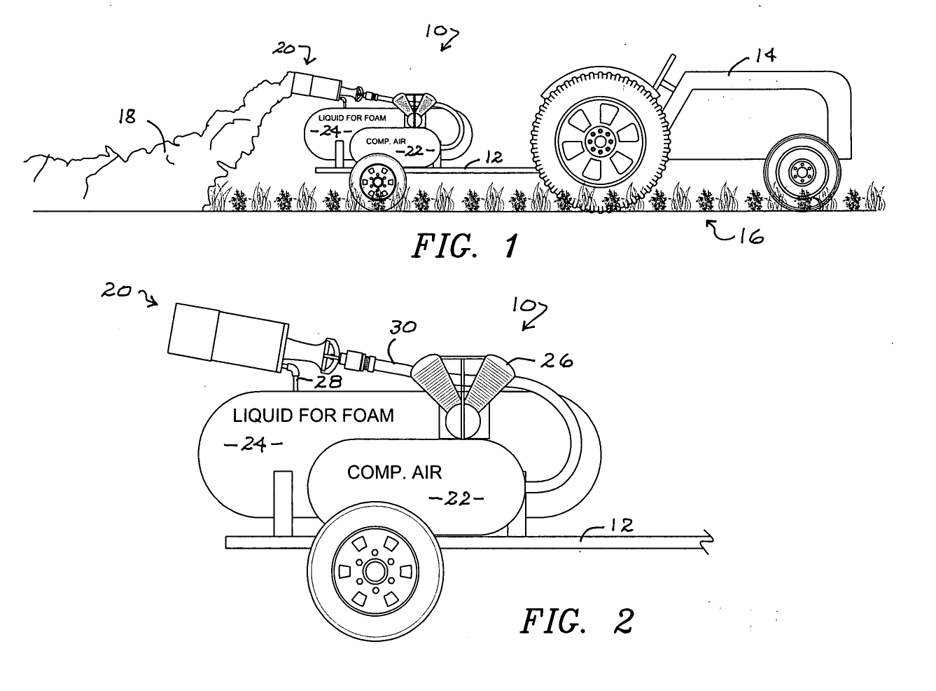

Referring to the more detailed view of FIG. 2, it can be seen that, in addition to foam generator nozzle 20, foam generator 10 comprises a source of compressed air 22 and a foam liquid source 24. The source of compressed air 22 may be powered by an engine 26, as illustrated. Alternatively, the source of compressed air may be powered by a power take off from tractor 14. A pump (not shown) is also provided for the purpose of supplying foam liquid to the foam generator nozzle 20 through liquid conduit 28. Compressed air is delivered to foam generator nozzle 20 through air conduit 30.

It is to be understood that while the views of FIGS. 1 and 2 provide for a single foam generator nozzle 20, the scope of the present invention is not to be limited thereby. Dependent upon operating conditions and the type and spacing of the particular agricultural crop being foamed, foam generator 10 may comprise a plurality of foam generator nozzles 20, with each such nozzle 20 operatively connected to the source of compressed air 22 and the foam liquid source 24, preferably in a parallel arrangement. It is also to be understood that depending upon the number and size of the foam generator nozzles 20 that are operatively mounted on a foam generator 10, the use of booster pumps, or similar delivery devices, for the foam liquid and the compressed air may be added in accord with well-known techniques.

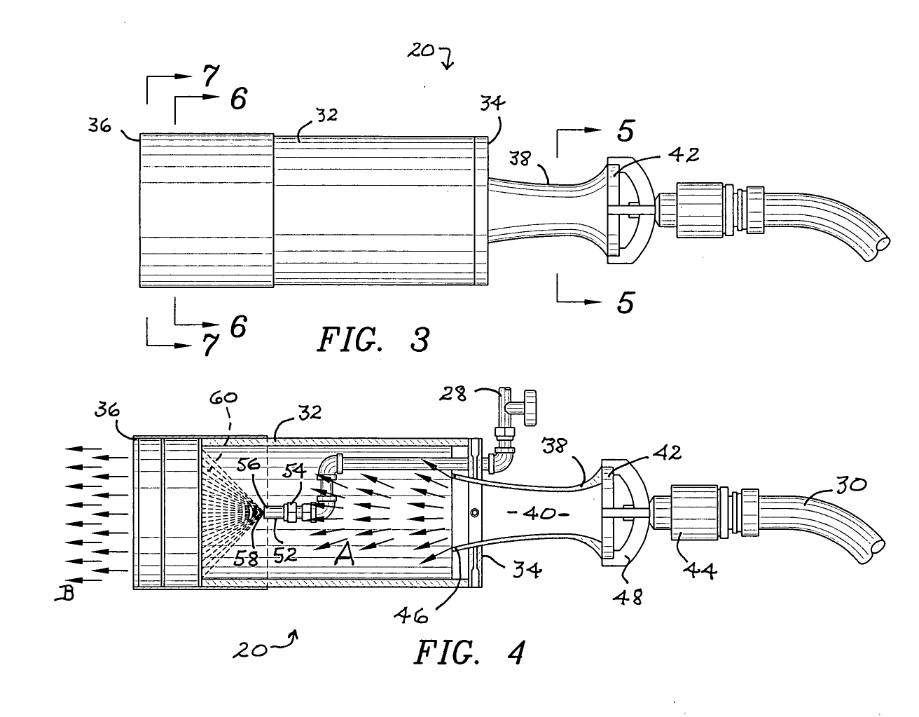

Turning to the views of FIGS. 3 and 4, structural details of the preferred foam generator nozzle 20 are provided. According to the preferred embodiment shown in FIGS. 3 and 4, foam generator nozzle 20 comprises a substantially cylindrical nozzle body 32 having a proximal end 34 and a distal end 36, to define an interior volume there between. The inside diameter of nozzle body 32 is about 6 inches, and the axial distance between proximal end 34 and distal end 36 is slightly more than 10 inches. Of course, these precise dimensions are not to be interpreted as limiting factors on the scope of the present invention.

Operatively attached to nozzle body proximal end 34 in fluid-delivery relation to the interior volume of nozzle body 34 is a venturi nozzle 38. As perhaps best seen in the view of FIG. 4, venturi nozzle 38 comprises a venturi throat 40 having a first end 42 operatively connected to the source of compressed air 22 by air conduit 30 and air delivery fitting 44. Compressed air from compressed air source 22 passes through venturi throat 40, past venturi throat discharged end 46, and into the interior volume of nozzle body 32, as indicated by the directional arrows A in FIG. 4.

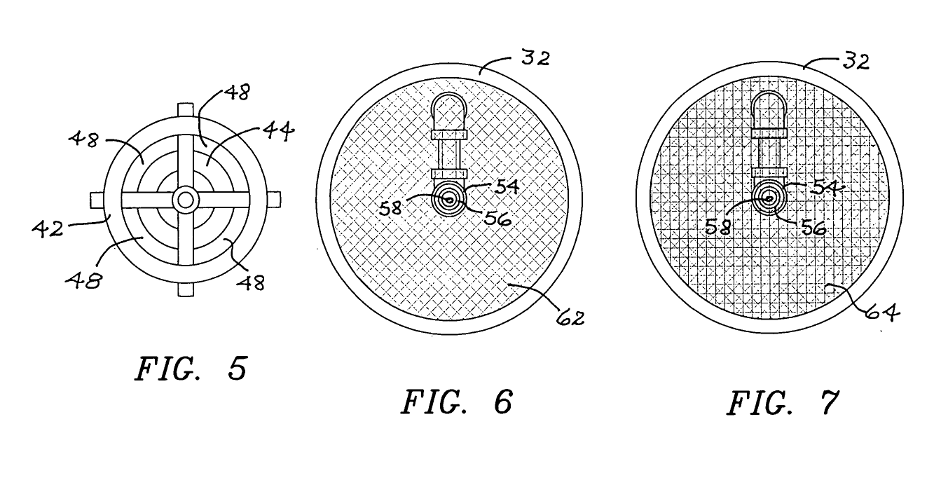

Referring to the sectional view of FIG. 5, one can see that first end 42 of venturi throat 40 further comprises a plurality of ambient air ports 48 whereby ambient air is also drawn through venturi throat 40 to the interior volume of nozzle body 32. Support arms 50 are provided for the purpose of attaching air delivery fitting 44 to first end 42.

Returning to the sectional view of FIG. 4, further details of the nozzle body 32 are provided. As shown in that figure, a liquid nozzle 52 is operatively disposed within the interior volume of nozzle body 32 downstream from nozzle body proximal end 34. Liquid nozzle 52 comprises a foam liquid receiving end 54 and a foam liquid spray end 56. Foam liquid spray end 56 further comprises a spray tip 58 that preferably emits a substantially solid, conical spray 60 of foam liquid. The intimate mixture of the flow of compressed and ambient air A, indicated by arrows with spray 60 creates a first foam that impinges upon first fluid dispersion medium 62.

As the first foam passes through first fluid dispersion medium 62 by the excess pressure created within the interior of nozzle body 32 the foam bubbles are further broken down, resulting in the formation of a second foam downstream from the first fluid dispersion medium 62. In this preferred embodiment, first fluid dispersion medium 62 comprises a substantially circular #81 nylon screen. It is to be understood that neither this precise material nor screen size is intended to limit the scope of the present invention, for other similar materials of appropriate size would also be useful.

Downstream from first fluid dispersion medium 62, and still within the interior volume of nozzle body 32 is placed a second fluid dispersion medium 64. According to the preferred embodiment, second fluid dispersion medium comprises of substantially circular #104 nylon screen. Of course, as already indicated above, the scope of this invention is not to be limited to that particular material, nor that precise screen size. However, it is important that the apertures through the second fluid dispersion medium 64 be smaller than the apertures through the first fluid dispersion medium 62. Thus, as the second foam passes through second fluid dispersion medium 64, the bubbles are further broken down to result in the formation of the substantially dry foam 18 of the present invention. Dry foam 18 is dispensed as indicated by arrows B.

Having thus set forth a preferred construction for both the foam generator 10 and the foam generator nozzle 20 of the present invention, attention is now invited to the operating parameters which are significant in proper use of this invention to generate an acceptable substantially dry foam 18 used for frost prevention.

First, it is to be understood that both the operating pressure and flow rate of foam liquid and compressed air are important for the formation of a substantially dry form 18. This is particularly true because, unlike current, state of the art foam generators, it is the compressed air and ambient air that are passed through venturi nozzle 38 to impinge and mix with conical spray 60 of the foam liquid, rather than passing the liquid through a venturi. Acceptable operating pressures for the compressed air fall in the range of from about 2 psi to about 20 psi, and acceptable flow rate for compressed air is from about the 14 cfm to about 221 cfm. With regard to the foam liquid, the liquid is delivered to liquid nozzle 52 at a pressure of from about 100 psi to about 300 psi, and at a flow rate of about 0.22 gpm to about 1.02 gpm. Spray tip 58 comprises a spray aperture of from about 0.031 inches to about 0.063 inches. In this preferred embodiment, spray tip 58 is centrally disposed along the axis of the interior of nozzle body 32 approximately 6 inches downstream from discharge end 46 of venturi throat 40. First fluid dispersion medium 62 is approximately 4 inches downstream from spray tip 58, and second fluid dispersion medium 64 is approximately 2 inches downstream from first fluid dispersion medium 62.

According to a second preferred method for generating dry foam 18, compressed air is delivered to first end 42 of venturi throat 40 at a pressure of from about 3 psi to about 11 psi, and at a flow rate of about 35 cfm to about 48 cfm. Foam liquid is delivered to liquid nozzle 52 at a pressure of from about 100 psi to about 300 psi, and at a flow rate of about 0.3 gpm to about 1.02 gpm.

A third preferred set of operating parameters comprises delivering compressed air to first end 42 of venturi throat 40 at a pressure of about 3 psi to about 5 psi, and at a flow rate of about 35 cfm. In this third preferred embodiment, foam liquid is delivered to liquid nozzle 52 at a pressure of about 300 psi, and at a flow rate of about 0.5 gpm. The spray aperture of spray tip 58 is about 0.036 inches. Utilizing this third preferred operating embodiment, foam generator 10 will produce about 700 gpm of substantially dry foam 18.

It will thus be seen that the objects set forth above, among those made apparent from the preceding description are efficiently attained, and since certain changes may be made in the construction set forth and in carrying out the above method without departing from the scope of the invention, it is intended that all matter contained in the above description or shown in the accompanying drawings shall be interpreted as illustrated and not in a limiting sense.

It is also to be understood that the following claims are intended to cover all of the generic and specific features of the invention herein described, and all statements of the scope of the invention which, as a matter of language, might be said to fall there between.

Now that the invention has been described,

What is claimed is:

1. A foam generator nozzle for producing and dispensing a substantially dry foam on an agricultural crop for frost protection, said foam generator nozzle comprising: a nozzle body defining an interior volume and comprising a proximal end and a distal end; a venturi nozzle operatively attached to said nozzle body proximal end in fluid-delivery relation to the interior volume of said nozzle body, said venturi nozzle comprising a venturi throat having a first end and a discharge end, said discharge end being in fluid-delivery relation to the interior volume of said nozzle body, and said first end of said venturi throat being operatively connected to a source of compressed air in fluid-receiving relation to the compressed air, said first end of said venturi throat further comprising a plurality of ambient air ports whereby ambient air is drawn into said venturi throat as the compressed air passes therethrough; said foam generator nozzle further comprising a liquid nozzle operatively disposed within the interior volume of said nozzle body downstream from said nozzle body proximal end, said liquid nozzle comprising a foam liquid receiving end and a foam liquid spray end, said foam liquid receiving end being operatively connected to a source of foam liquid in liquid-receiving relation to the foam liquid, said foam liquid spray end comprising a spray tip whereby the foam liquid is sprayed into the interior of said nozzle body for mixing with the flow of compressed air and ambient air from said venturi nozzle discharge end to produce a first foam; said foam generator nozzle further comprising a first fluid dispersion medium disposed within said nozzle body downstream from said liquid nozzle in transverse relation to the flow of said first foam, said first fluid dispersion medium comprising a plurality of first apertures formed therethrough to produce a second foam as said first foam passes through said first apertures; and said foam generator nozzle further comprising a second fluid dispersion medium disposed within said nozzle body downstream from said first fluid dispersion medium in transverse relation to the flow of said second foam, said second fluid dispersion medium comprising a plurality of second apertures formed therethrough to produce the dry foam as said second foam passes through said second apertures for application to an agricultural crop from said nozzle body distal end.

2. A foam generator for producing and dispensing a substantially dry foam on an agricultural crop for frost protection, said foam generator comprising: a foam liquid source; a compressed air source; and at least one foam generator nozzle operatively connected to said foam liquid source and to said compressed air source for receiving the foam liquid and the compressed air; said foam generator nozzle comprising a nozzle body defining an interior volume and comprising a proximal end and a distal end; a venturi nozzle operatively attached to said nozzle body proximal end in fluid-delivery relation to the interior volume of said nozzle body, said venturi nozzle comprising a venturi throat having a first end and a discharge end, said discharge end being in fluid-delivery relation to the interior volume of said nozzle body, and said first end of said venturi throat being operatively connected to said source of compressed air in fluid-receiving relation to the compressed air, said first end of said venturi throat further comprising a plurality of ambient air ports whereby ambient air is drawn into said venturi throat as the compressed air passes therethrough; said foam generator nozzle further comprising a liquid nozzle operatively disposed within the interior volume of said nozzle body downstream from said nozzle body proximal end, said liquid nozzle comprising a foam liquid receiving end and a foam liquid spray end, said foam liquid receiving end being operatively connected to said source of foam liquid in liquid-receiving relation to the foam liquid, said foam liquid spray end comprising a spray tip whereby the foam liquid is sprayed into the interior of said nozzle body for mixing with the flow of compressed air and ambient air from said venturi nozzle discharge end to produce a first foam; said foam generator nozzle further comprising a first fluid dispersion medium disposed within said nozzle body downstream from said liquid nozzle in transverse relation to the flow of said first foam, said first fluid dispersion medium comprising a plurality of first apertures formed therethrough to produce a second foam as said first foam passes through said first apertures; and said foam generator nozzle further comprising a second fluid dispersion medium disposed within said nozzle body downstream from said first fluid dispersion medium in transverse relation to the flow of said second foam, said second fluid dispersion medium comprising a plurality of second apertures formed therethrough to produce the dry foam as said second foam passes through said second apertures for application to an agricultural crop from said nozzle body distal end.

3. A method for producing and dispensing a substantially dry foam on agricultural crops for frost protection using the foam generator of claim 2 wherein said foam liquid is delivered to said liquid receiving end of said liquid nozzle at a pressure of from about 100 psi to about 300 psi, and wherein said spray tip comprises a spray aperture of about 0.031 in to about 0.063 in, and at a flow rate of about 0.22 gpm to about 1.02 gpm; and wherein said compressed air is delivered to said first end of said venturi throat at a pressure of about 2 psi to about 20 psi, and at a flow rate of about 14 cfm to about 221 cfm.

4. A method for producing and dispensing a substantially dry foam on agricultural crops for frost protection using the foam generator of claim 2 wherein said foam liquid is delivered to said liquid receiving end of said liquid nozzle at a pressure of from about 100 psi to about 300 psi, and wherein said spray tip comprises a spray aperture of about 0.036 in to about 0.063 in, and at a flow rate of about 0.3 gpm to about 1.02 gpm; and wherein said compressed air is delivered to said first end of said venturi throat at a pressure of about 3 psi to about 11 psi, and at a flow rate of about 35 cfm to about 48 cfm.

5. A method for producing and dispensing a substantially dry foam on agricultural crops for frost protection using the foam generator of claim 2 wherein said foam liquid is delivered to said liquid receiving end of said liquid nozzle at a pressure of about 300 psi, and wherein said spray tip comprises a spray aperture of about 0.036 in, and at a flow rate of about 0.5 gpm; and wherein said compressed air is delivered to said first end of said venturi throat at a pressure of about 3 psi to about 5 psi, and at a flow rate of about 35 cfm.

6. A method for producing and dispensing a substantially dry foam on agricultural crops for frost protection using the foam generator of claim 2 wherein said foam liquid is delivered to said liquid receiving end of said liquid nozzle at a pressure of about 300 psi, and wherein said spray tip comprises a spray aperture of about 0.036 in, and at a flow rate of about 0.5 gpm; and wherein said compressed air is delivered to said first end of said venturi throat at a pressure of about 3 psi to about 5 psi, and at a flow rate of about 35 cfm to dispense about 700 gpm of said foam.

7. A method for producing and dispensing a substantially dry foam on agricultural crops for frost protection using the foam generator of claim 6 wherein said first fluid dispersion medium comprises a #81 nylon screen, and wherein said second fluid dispersion medium comprises a #104 nylon screen.

8. A method for producing and dispensing a substantially dry foam on agricultural crops for frost protection using the foam generator of claim 7 wherein said second fluid dispersion medium is disposed about 2 in downstream from said first fluid dispersion medium to define a volume of about 56.5 in³ between said first fluid dispersion medium and said second fluid dispersion medium.

9. A method for producing and dispensing a substantially dry foam on agricultural crops for frost protection using the foam generator of claim 7 wherein said second fluid dispersion medium is disposed downstream from said first fluid dispersion medium to define a volume between said first fluid dispersion medium and said second fluid dispersion medium that is about 16.6% of said interior volume of said nozzle body.
